(19) United States
(12) Patent Application Publication
(10) Pub. No.: US 2024/0378587 A1
(43) Pub. Date: Nov. 14, 2024

(54) SYSTEMS AND METHODS FOR FACILITATING FINANCIAL TRANSACTIONS VIA A REMOVABLE CHIPSET

(71) Applicant: Wells Fargo Bank, N.A., San Francisco, CA (US)

(72) Inventors: Rameshchandra Bhaskar Ketharaju, Hyderabad (IN); Justin Blackburn, Litchfield Park, AZ (US)

(21) Appl. No.: 18/314,652

(22) Filed: May 9, 2023

(51) Int. Cl. G06Q 20/32; G06Q 20/40

(52) U.S. Cl. CPC G06Q 20/3278; G06Q 20/4014

(57) ABSTRACT

Systems, apparatuses, methods, and computer program products are disclosed for facilitating financial transactions via a removable chipset. An example system includes a mobile device and a removable second chipset operably coupled to the mobile device and configured to store sensitive data and facilitate financial transactions using the sensitive data. The removable second chipset includes communications hardware configured to receive configuration data. The removable second chipset also includes a rules engine configured to generate a ruleset for the second chipset based on the configuration data. The removable second chipset also includes a transaction engine configured to facilitate a financial transaction in accordance with the ruleset.

### BACKGROUND

Payment chips are often susceptible to various attacks, such as man-in-the-middle (MITM) attacks, PIN harvesting, and the like. Payment chips may also not be compatible with all types of payment systems.

### BRIEF SUMMARY

A common type of payment chip seen today is an EMV (Europay, Mastercard, and Visa) chip. EMV chips are integrated circuit cards typically present on debit or credit cards which are configured to be physically inserted into a reader or read over a short distance using near-field communication (NFC) technology. EMV cards are one of the most widely used and accepted forms of payments globally. EMV cards are configured with a magnetic stripe and an EMV chip, both of which are encoded to store information required to authenticate, authorize, and process transactions. While convenient, EMV cards are susceptible to a variety of attacks such as MITM attacks, PIN harvesting, stripe cloning, and the like. While attempts may be made to mitigate the risk of EMV cards by applying expiration dates to the cards, these expiration dates typically range between 3 to 5 years from the date of issue, thus opening up the opportunity for fraudulent use to occur for many years. Additionally, single use cards are typically virtual, and may be difficult to utilize with point-of-sale (POS) terminals.

In recent years, the ubiquity of mobile devices (e.g., mobile phones, smartwatches, and the like) has led to a rise in their use as payment facilitators, which has reduced the need to carry physical debit or credit cards. Mobile wallet platforms have seen increased popularity, as users can simply store their credit card information on their phones and make payments at the touch of a button. This trend is expected to continue, as more retailers adopt mobile payment technology and users become more comfortable with mobile wallet payments.

While mobile payment platforms have revolutionized the way individuals make payments, these platforms also bring several drawbacks and limitations, particularly when it comes to security. For instance, like other online platforms, mobile payment platforms are vulnerable to data breaches, which may compromise personal financial information of users. Additionally, if a mobile device is lost or stolen, it can potentially give others access to the user's mobile payment account, which could lead to unauthorized purchases and/or identity theft. Further, third-party mobile payment applications installed on a mobile device may also be susceptible to malware or other harmful software that is also present on the mobile device.

In contrast to these conventional payment techniques, example embodiments described herein provide a removable and dedicated payment chipset that is configured to interface with a variety of devices (e.g., mobile devices) and can facilitate financial transactions either online or in-person. In some embodiments, the removable chipset may be configured to be temporary and may be replaced or reconfigured at a user's discretion. In some embodiments, the removable chipset may be configured according to certain rules and preferences defined by a user.

In some embodiments, the removable payment chipset may be implemented in a system-on-chip (SOC) configuration, such that the removable payment chipset comprises a plurality of dedicated components separate and distinct from similar components that make up a device to which the removable payment chipset may be connected. In this manner, in some embodiments, the removable payment chipset may serve as an additional factor in multifactor authentication processes necessitated by certain financial transactions. Further, the SOC configuration of the removable payment chipset provides enhanced security by isolating authentication and payment functionalities from other potentially compromised areas of a device to which the removable payment chipset is connected. In some embodiments, as discussed further herein, the removable payment chipset may utilize capabilities of advanced cellular networks (e.g., sixth generation (6G) cellular networks) to increase security of financial transactions facilitated by the removable payment chipset.

In some embodiments, the removable payment chipset may be preconfigured and included as a component of certain devices (e.g., mobile phones) at the time of purchase, thus providing users an easy entrance into a higher level of security for their financial transactions. In some embodiments, the removable payment chipset may be customized and configured to a high degree by a user via a graphical user interface (GUI). In this regard, a user may define configuration data which in turn may be leveraged by the removable payment chipset to define a ruleset for financial transactions facilitated by the removable payment chipset. As one example, the removable payment chipset may be configured to only allow for certain transaction types (e.g., only for transportation fare). As such, the customizable settings of the removable payment chipset may help prevent fraudulent usage while also being tailored to serve a user's particular needs. Accordingly, the present disclosure sets forth systems, methods, and apparatuses that improve protection of sensitive information (including both personal and financial information) by facilitating financial transactions via a removable chipset.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for facilitating financial transactions via a removable chipset.

FIG. 2 illustrates a schematic block diagram of example circuitry embodying a device that may perform various operations in accordance with some example embodiments described herein.

FIG. 3 illustrates a schematic block diagram of example circuitry embodying a removable chipset that may perform various operations in accordance with some example embodiments described herein.

FIG. 4 illustrates an example flowchart for facilitating financial transactions via a removable chipset, in accordance with some example embodiments described herein.

FIG. 5 illustrates an example flowchart for receiving configuration data via a configuration interface, in accordance with some example embodiments described herein.

FIG. 6 illustrates an example flowchart for authenticating a user in connection with facilitating a financial transaction, in accordance with some example embodiments described herein.

FIG. 7 illustrates an example flowchart for determining a transmission channel for payment information in connection with a financial transaction, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), Internet-of-Things (IoT) devices and similar connected devices (e.g., connected appliances, doorbell systems, security systems, home assistant systems, and the like), and similar electronic devices equipped with at least a processor and any other physical components necessarily to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, payment server, or any other type of server. A server may be a dedicated computing device or a server module (e.g., an application) hosted by a computing device that causes the computing device to operate as a server.

### System Architecture

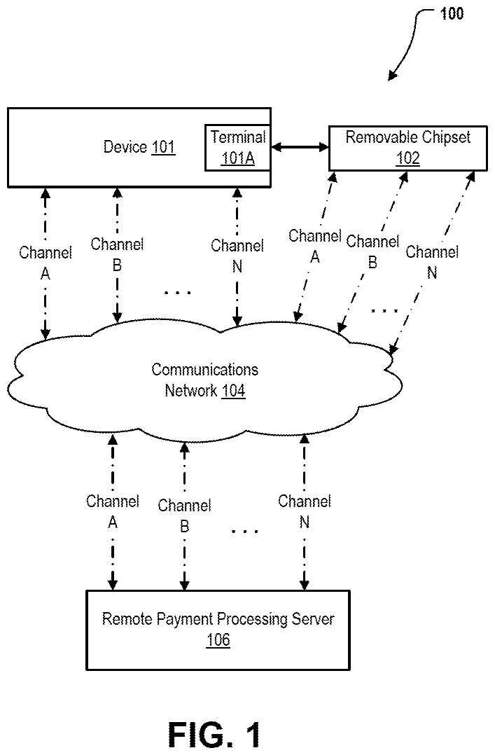

Example embodiments described herein may be implemented using any of a variety of devices or servers. To this end, FIG. 1 illustrates an example environment 100 within which various embodiments may operate. As illustrated, a device 101 and removable chipset 102 may receive and/or transmit information via communications network 104 (e.g., the Internet) with any number of other devices or servers, such as one or more remote payment processing servers, shown as remote payment processing server 106.

In some embodiments, the communications network may comprise a cellular network, such as a sixth generation (6G) cellular network or similar advanced cellular network. In this regard, example embodiments may leverage advanced capabilities of a cellular network in order to carry out various operations described herein. For example, a 6G cellular network may offer faster and more reliable data transmission than previous generations of cellular networks, as well as new technologies such as terahertz frequencies, beamforming, and massive MIMO (Multiple Input, Multiple Output) which uses multiple antennas to send and receive signals, thereby improving signal strength and overall capacity of the network. To this end, communications network 104 may comprise a variety of devices not explicitly shown in FIG. 1, such as base stations, antennas, edge devices (e.g., routers), and/or the like which serve various functions in transmitting data throughout the communications network (e.g., transmitting data from device 101 and/or removable chipset 102 to remote payment processing server 106).

In some embodiments, as shown for example in FIG. 1, data may be transmitted over the communications network 104 (e.g., a cellular network, such as a 6G cellular network) via a plurality of different transmission channels (shown as Channel A, Channel B, through Channel N). In this regard, data (e.g., data packets) may be transmitted over certain frequencies or transmission channels based on various factors (e.g., signal strength, network congestion, quality of service (QOS), carrier aggregation, and/or the like). In some embodiments, specific transmission channels may be selected and/or requested for transmitting certain data. For example, certain transmission channels may be dedicated to transmitting certain types of data, such as authentication data, payment tokens, and/or the like. In some embodiments, selection of a transmission channel for sending data may be randomized for purposes of enhanced fraud prevention, as further discussed herein.

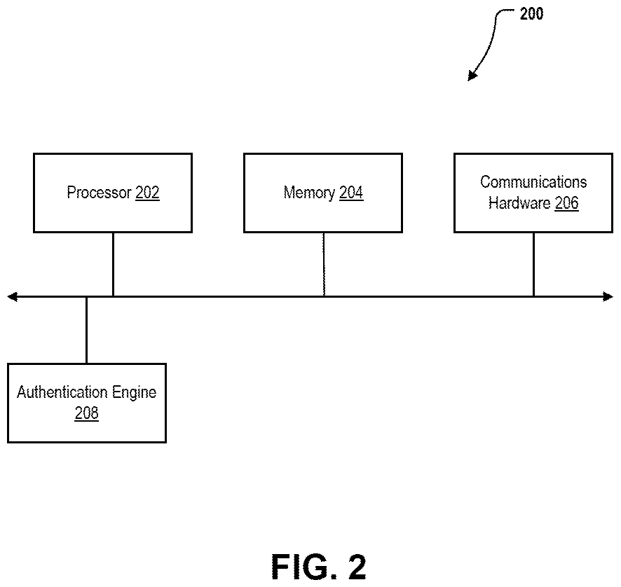

The device 101 may be implemented as one or more devices or servers, which may be composed of a series of components (e.g., distinct from components of the removable chipset 102). Particular components of the device 101 are described in greater detail below with reference to apparatus 200 in connection with FIG. 2. In some embodiments, device 101 may comprise a terminal 101A (e.g., a port) to which a removable chipset 102 may be operably coupled. The terminal 101A may be configured to accept a removable chipset 102 of a particular form factor. In some embodiments, terminal 101A is a specifically configured port for the removable chipset 102. In some embodiments, the removable chipset 102 may be configured to interface with certain terminals requiring specific form factors, such as, for example, Universal Serial Bus (USB) ports, micro-USB ports, Secure Digital (SD) card or memory card slots, Lightning ports, and/or the like.

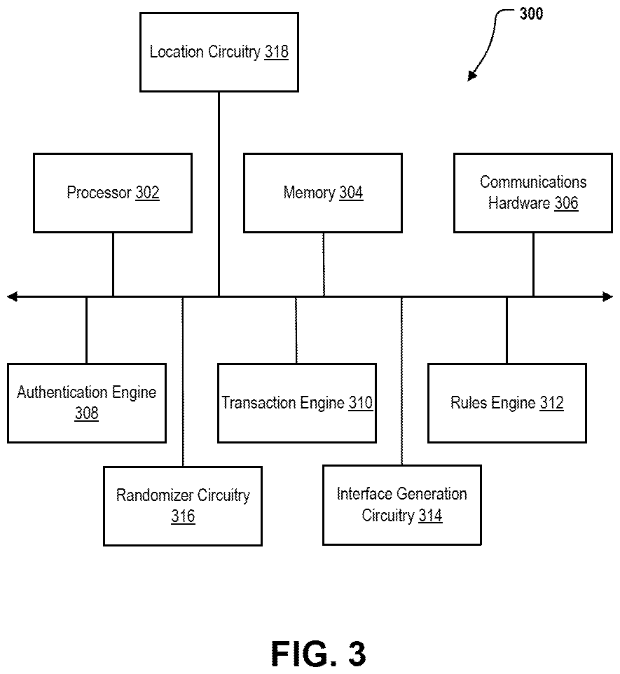

In some embodiments, the removable chipset 102 may be implemented as a separate device (e.g., a peripheral device) configured to be operably coupled to (and removable from) device 101 (e.g., via terminal 101A). In some embodiments, the removable chipset 102 may comprise a system-on-chip (SOC) composed of a series of components (e.g., distinct from components of the device 101). Particular components of the removable chipset 102 are described in greater detail below with reference to apparatus 300 in connection with FIG. 3.

### Example Implementing Apparatuses

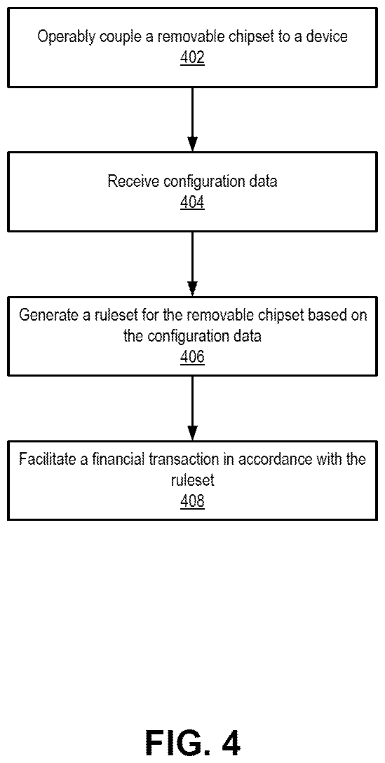

The device 101 (described previously with reference to FIG. 1) may be embodied by one or more devices or servers, shown as apparatus 200 in FIG. 2. The apparatus 200 may be configured to execute various operations described above in connection with FIG. 1 and below in connection with FIGS. 4-7. As illustrated in FIG. 2, the apparatus 200 may include processor 202, memory 204, communications hardware 206, and an authentication engine 208, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network (e.g., communications network 104, such as a cellular network) and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

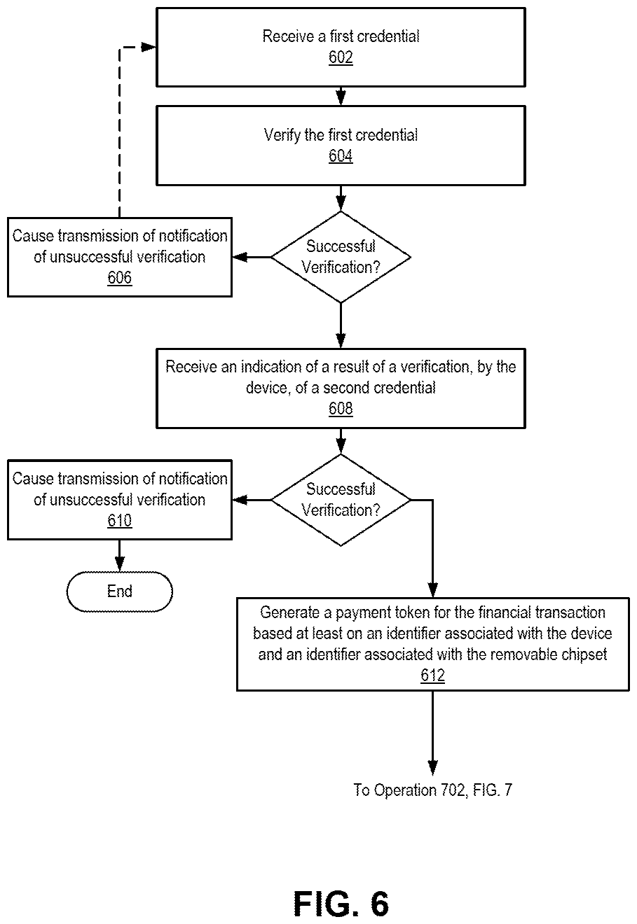

In addition, the apparatus 200 further comprises an authentication engine 208 that verifies one or more authentication factors. The authentication engine 208 may utilize processor 202, memory 204, or any other hardware component included in the apparatus 200 (e.g., the device) to perform these operations, as described in connection with FIG. 6 below. The authentication engine 208 may further utilize communications hardware 206 to gather data from a variety of sources (e.g., remote devices or systems storing reference authentication factors or similar information), and/or exchange data with a user, and in some embodiments may utilize processor 202 and/or memory 204 to verify one or more authentication factors. For example, verification factors provided via device 101 (e.g., a fingerprint sensor) may be verified by authentication engine 208 as a component of the device 101.

Although components 202-208 are described in part using functional language, it will be understood that the particular implementations necessarily include the use of particular hardware. It should also be understood that certain of these components 202-208 may include similar or common hardware. For example, the authentication engine 208 may at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatuses 200 and 220 (discussed below) to perform the various functions described herein.

Although the authentication engine 208 may leverage processor 202, memory 204, or communications hardware 206 as described above, it will be understood that authentication engine 208 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication engine 208 comprises particular machinery designed for performing the functions described herein in connection with such elements of apparatus 200.

As illustrated in FIG. 3, an apparatus 300 is shown that represents an example removable chipset (e.g., removable chipset 102). As noted above, the removable chipset 102 may be implemented in an SOC configuration, e.g., as an integrated circuit that includes many or all components of a computer on a single substrate or microchip. In this regard, the removable chipset 102 comprises separate and distinct components from the components of device 101 (as described above in connection with apparatus 200 of FIG. 2).

The processor 302 (and/or co-processor or any other processor assisting or otherwise associated with the processor) may be in communication with the memory 304 via a bus for passing information amongst components of the apparatus 300. The processor 302 may be embodied in a number of different ways and may, for example, include one or more processing devices configured to perform independently. Furthermore, the processor may include one or more processors configured in tandem via a bus to enable independent execution of software instructions, pipelining, and/or multithreading. As noted above, the term “processor” may be understood to include a single core processor, a multi-core processor, multiple processors of the apparatus 300, remote or “cloud” processors, or any combination thereof.

In some embodiments, for example embodiments in which the removable chipset 102 comprises an SOC, the processor 302 may comprise at least one processor core which may include a microcontroller, microprocessor, digital signal processor (DSP), and/or application-specific instruction set processor (ASIP) core. For example, an ASIP may comprise instruction sets that are customized for an application domain and designed to be more efficient than general-purpose instructions for a specific type of workload. In this regard, the ASIP may comprise a configurable instruction set. The ASIP core may be divided into two parts including static logic (which defines a minimum instruction-set architecture) and configurable logic (which can be used to design new instructions, e.g., rulesets and payment configuration, further discussed herein). The configurable logic may be programmed in the field (e.g., by a user after purchase or attainment of the removable chipset 102) in a similar fashion to a field-programmable gate array (FPGA), and/or during the chipset synthesis.

The processor 302 may be configured to execute software instructions stored in the memory 304 or otherwise accessible to the processor 302. In some cases, the processor 302 may be configured to execute hard-coded functionality. As such, whether configured by hardware or software methods, or by a combination of hardware with software, the processor 302 represent an entity (e.g., physically embodied in circuitry) capable of performing operations according to various embodiments of the present invention while configured accordingly. Alternatively, as another example, when the processor 302 is embodied as an executor of software instructions, the software instructions may specifically configure the processor 302 to perform the algorithms and/or operations described herein when the software instructions are executed.

Memory 304 is non-transitory and may include, for example, one or more volatile and/or non-volatile memories. In other words, for example, the memory 304 may be an electronic storage device (e.g., a computer readable storage medium). The memory 304 may be configured to store information, data, content, applications, software instructions, or the like, for enabling the apparatus 300 to carry out various functions in accordance with example embodiments contemplated herein. In some embodiments, for example embodiments in which the removable chipset 102 comprises an SOC, the memory 304 may be implemented as semiconductor memory blocks, and the memory 304 may form a memory hierarchy and cache hierarchy. Memory 304 may comprise read-only memory (ROM), random-access memory (RAM), Electrically Erasable Programmable ROM (EEPROM), and/or flash memory.

The communications hardware 306 may be any means such as a device or circuitry embodied in either hardware or a combination of hardware and software that is configured to receive and/or transmit data from/to a network (e.g., communications network 104, such as a cellular network) and/or any other device, circuitry, or module in communication with the apparatus 300 (e.g., device 101 and/or payment processing server 106). In this regard, the communications hardware 306 may include, for example, a network interface for enabling communications with a wired or wireless communication network (e.g., a cellular network). For example, the communications hardware 306 may include one or more network interface cards, antennas, buses, switches, routers, modems, and supporting hardware and/or software, or any other device suitable for enabling communications via a network. Furthermore, the communications hardware 306 may include the processor for causing transmission of such signals to a network or for handling receipt of signals received from a network.

The communications hardware 306 may further be configured to provide output to a user and, in some embodiments, to receive an indication of user input. In this regard, the communications hardware 306 may comprise a user interface, such as a display, and may further comprise the components that govern use of the user interface, such as a web browser, mobile application, dedicated client device, or the like. In some embodiments, the communications hardware 306 may utilize or otherwise communicate data to communications hardware 206 (of device 101) to facilitate presentation of data, such as user interfaces, e.g., via a display screen of device 101. The communications hardware 306 may utilize the processor 302 to control one or more functions of one or more of these user interface elements through software instructions (e.g., application software and/or system software, such as firmware) stored on a memory (e.g., memory 304) accessible to the processor 302.

As discussed above, in some embodiments, the removable chipset 102 may be operably coupled to device 101 via a terminal 101A (and other devices and their respective terminals). In some embodiments, the removable chipset 102 may also include a protective housing that conceals the components (e.g., as shown in FIG. 3) of the removable chipset 102. The protective housing may comprise one or more connectors which are arranged to connect the removable chipset to external devices (e.g., device 101). In some embodiments, the terminal 101A may be configured to accept the removable chipset 102 such that the removable chipset 102 is completely inserted into the terminal 101A. In some other embodiments, some portion of the removable chipset 102 (including the protective housing) may remain exposed when inserted into the terminal 101A.

The apparatus 300 (e.g., the removable chipset 102) further comprises an authentication engine 308 that verifies one or more authentication factors. The authentication engine 308 may utilize processor 302, memory 304, or any other hardware component included in the apparatus 300 to perform these operations, as described in connection with FIGS. 4-7 below. The authentication engine 308 may further utilize communications hardware 306 to gather data from a variety of sources (e.g., device 101 and/or remote devices or systems storing reference authentication factors or similar information), and/or exchange data with a user, and in some embodiments may utilize processor 302 and/or memory 304 to verify one or more authentication factors. For example, verification factors provided via device 101 (e.g., a fingerprint sensor) may be verified by authentication engine 308 as a component of the removable chipset 102. In some embodiments, as discussed herein, authentication engine 208 and authentication engine 308 may both be used to verify a plurality of authentication factors such that both the device 101 and the removable chipset 102 serve as separate factors in a multifactor authentication (MFA) process.

The apparatus 300 further comprises a transaction engine 310 that facilitates financial transactions in accordance with the ruleset. The transaction engine 310 may utilize processor 302, memory 304, or any other hardware component included in the apparatus 300 to perform these operations, as described in connection with FIGS. 4-7 below. The transaction engine 310 may further utilize communications hardware 306 to gather data from a variety of sources (e.g., device 101 and/or remote devices or systems), and/or exchange data with a user, and in some embodiments may utilize processor 302 and/or memory 304 to facilitate financial transactions.

The apparatus 300 further comprises a rules engine 312 that generates a ruleset for the removable chipset based on configuration data. The rules engine 312 may utilize processor 302, memory 304, or any other hardware component included in the apparatus 300 to perform these operations, as described in connection with FIGS. 4-7 below. The rules engine 312 may further utilize communications hardware 306 to gather data from a variety of sources (e.g., device 101 and/or remote devices or systems), and/or exchange data with a user, and in some embodiments may utilize processor 302 and/or memory 304 to generate a ruleset.

The apparatus 300 further comprises interface generation circuitry 314 that generates a configuration interface. The interface generation circuitry 314 may utilize processor 302, memory 304, or any other hardware component included in the apparatus 300 to perform these operations, as described in connection with FIGS. 4-7 below. The interface generation circuitry 314 may further utilize communications hardware 306 to gather data from a variety of sources (e.g., device 101 and/or remote devices or systems), and/or exchange data with a user, and in some embodiments may utilize processor 302 and/or memory 304 to generate a configuration interface and/or other user interfaces associated with the removable chipset 102. The interface generation circuitry 314 may utilize communications hardware 306 and/or communications hardware 206 (of device 101) to cause display of a configuration interface via a display screen of the device 101. In this manner, configuration data (e.g., for the removable chipset 102) may be received in response to user interaction with the configuration interface (e.g., via display screen of the device 101).

The apparatus 300 further comprises randomizer circuitry 316 that generates a randomized value. In some embodiments, the randomized value may be used in selecting a transmission channel for data to be transmitted from the removable chipset 102. The randomizer circuitry 316 may utilize processor 302, memory 304, or any other hardware component included in the apparatus 300 to perform these operations, as described in connection with FIGS. 4-7 below. The randomizer circuitry 316 may further utilize communications hardware 306 to gather data from a variety of sources (e.g., device 101 and/or remote devices or systems), and/or exchange data with a user, and in some embodiments may utilize processor 302 and/or memory 304 to generate a randomized value. In some embodiments, the randomizer circuitry 316 may comprise one or more random number generators (RNG), such as a pseudo-random number generator (PRNG), a cryptographically secure random number generator (CS-RNG), or hardware-based RNG. At least a portion of the randomized value produced by the randomizer circuitry 316 may be used to select a transmission channel (which may map to a predefined value that matches or in some way corresponds to the randomized value).

The apparatus 300 further comprises location circuitry 318 that determines location data for the removable chipset 102 and causes transmission of location data for the removable chipset 102. In some embodiments, the location data may be used when attempting to locate the removable chipset 102 (e.g., in the event the removable chipset 102 is misplaced, lost, or stolen). The location circuitry 318 may utilize processor 302, memory 304, or any other hardware component included in the apparatus 300 to perform these operations, as described in connection with FIGS. 4-7 below. The location circuitry 318 may further utilize communications hardware 306 to gather data from a variety of sources (e.g., device 101 and/or remote devices or systems, such as Global Positioning System (GPS) satellite systems or the like), and/or exchange data with a user, and in some embodiments may utilize processor 302 and/or memory 304 to determine and cause transmission of location data for the removable chipset 102. In some embodiments, the location circuitry 318 may comprise a micro-GPS tracking chip (e.g., embedded on a substrate as a component of the SOC) configured to receive GPS signals from satellites and transmit location data (e.g., GPS coordinates) using wireless connectivity (e.g., via a cellular network) to a controlling device (e.g., device 101). In this regard, device 101 may have a GPS tracking application installed such that coordinates received from location circuitry 318 of the removable chipset 102 can be viewed or otherwise obtained by a user possessing the device 101.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions. While described above in slightly different terms, it will be appreciated that the apparatus 200 and apparatus 300 may be implemented in a similar manner in various embodiments. That is, in some embodiments, the apparatus 200 and apparatus 300 may each be implemented as an SOC. In some other embodiments, the apparatus 300 may be implemented as an SOC, while the apparatus 200 is not.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-7, example flowcharts are illustrated that contain example operations implemented by example embodiments described herein. The operations illustrated in FIGS. 4-7 may, for example, be performed by a removable chipset 102 shown in FIG. 1, which may in turn be embodied by an apparatus 300, which is shown and described in connection with FIG. 3. To perform the operations described below, the apparatus 300 may utilize one or more of processor 302, memory 304, communications hardware 306, authentication engine 308, transaction engine 310, rules engine 312, interface generation circuitry 314, randomizer circuitry 316, location circuitry 318, and/or any combination thereof. It will be understood that, in some embodiments, user interaction with the removable chipset 102 may occur directly via communications hardware 306, and in some embodiments may instead be facilitated by a device operably coupled to the removable chipset 102, such as device 101 as shown in FIG. 1, and which may have similar or equivalent physical componentry facilitating such user interaction.

Turning first to FIG. 4, example operations are shown for facilitating financial transactions via a removable chipset.

As shown by operation 402, the apparatus 300 (e.g., a removable chipset 102) may be operably coupled to a device. The removable chipset 102 may be operably coupled to a device via a terminal of the device that is communicatively coupled to constituent components of the device. In this regard, the device may include a chipset which is separate and distinct from the removable chipset. In some embodiments, operably coupling the removable chipset to a device may involve inserting the removable chipset into a terminal (such as a port, slot, or the like) of the device. As discussed above, the terminal may be a specifically configured port for the removable chipset 102. In some embodiments, the removable chipset 102 may be configured to interface with certain terminals designed for specific form factors (e.g., USB, micro-USB, SD card slots, memory card slots, or other form factors).

In some embodiments, a removable chipset may be included as part of a device, e.g., as part of a package when purchasing the device. For example, a mobile phone, when sold to a customer, may come with a removable chipset such that the customer obtains the removable chipset when purchasing the mobile phone. In this regard, the removable chipset may be preconfigured to interface and operate with the mobile phone (or other device). In some embodiments, the removable chipset may be preconfigured to be associated with a particular financial institution. In some examples, device manufacturers may partner with a financial institution and include preconfigured removable chipsets (which are associated with the financial institution) in their devices (e.g., mobile phones, smartwatches, etc.). In this manner, a customer may be onboarded with the financial institution in connection with both their device and removable chipset.

In some embodiments, a removable chipset may be preconfigured to be associated with a financial institution such that the removable chipset is preconfigured to interface with various systems and/or networks of the financial institution. For example, the removable chipset may be preconfigured to operate in connection with certain payment rails of the financial institution, e.g., the systems and infrastructure for the financial institution that facilitate movement of funds between parties. In some embodiments, a removable chipset may be obtained separately from one or more other devices. For example, a user may purchase a removable chipset as a standalone item to be operably coupled with one or more devices the user already possesses. In these embodiments, the removable chipset may still be preconfigured to be associated with a particular financial institution.

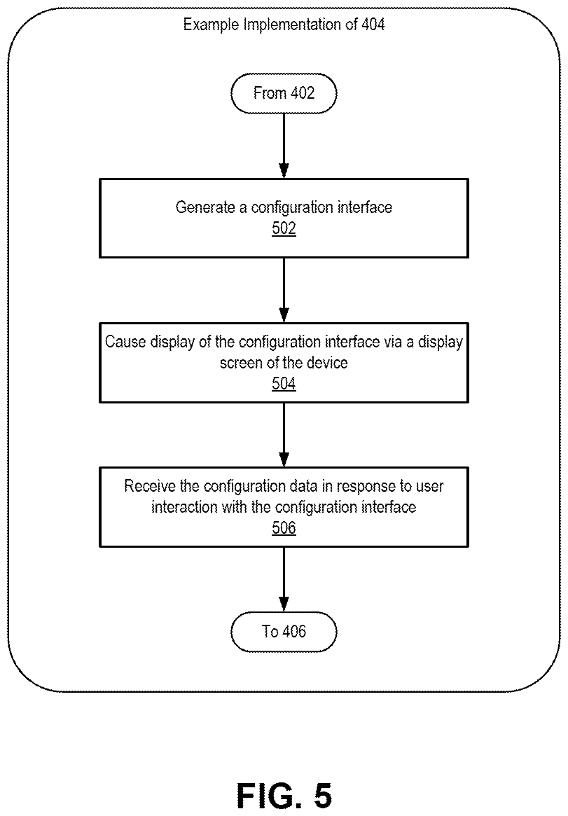

In some embodiments, as discussed further below in connection with FIG. 5, the removable chipset may be reconfigurable such that the removable chipset can be configured to interface and operate with one or more additional devices and/or financial institutions.

In some embodiments, as noted above, the removable chipset may operably couple to a variety of devices. For example, the removable chipset may operably couple to a mobile device (e.g., a mobile phone, smartwatch, or other device carried by a user). In some embodiments, the removable chipset may be operably coupled to a stationary device. For example, the removably chipset may be operably coupled to an IoT device, such as smart thermostats, security cameras, appliances (e.g., refrigerators, washing machines, etc.), smart sensors, home assistants, autonomous robots, and/or the like. For example, a removable chipset may be operably coupled to a specific device for which regular payments are made (e.g., via the removable chipset). For example, a monthly home security bill may be automatically paid via a removable chipset operably coupled to a device associated with home security system (e.g., a security camera).

As shown by operation 404, the apparatus 300 (e.g., the removable chipset 102) includes means, such as processor 302, memory 304, communications hardware 306, interface generation circuitry 30, or the like, for receiving configuration data. For example, once operably coupled to a device, a user may configure the removable chipset in various ways. To do so, in some embodiments, the removable chipset may generate a configuration interface (e.g., a graphical user interface (GUI)) which may be presented via a display screen of the device that the removable chipset is operably coupled to (e.g., device 101).

Turning briefly to FIG. 5, example operations for receiving configuration data via a configuration interface are shown.

As shown by operation 502, the apparatus 300 includes means, such as processor 302, memory 304, communications hardware 306, interface generation circuitry 30, or the like, for generating a configuration interface. In some embodiments, a configuration interface may be automatically generated in response to the removable chipset being operably coupled to a device. In some embodiments, the user may provide a request, e.g., via the device to which the removable chipset is operably coupled, for the removable chipset to generate a configuration interface.

The configuration interface may comprise one or more GUIs that allow a user to configure various aspects of the removable chipset. For example, the user may configure the chipset to be associated with one or more financial institutions (or remove previous associations to certain financial institutions). By interacting with the configuration interface, configuration data may be generated which may then be processed by the removable chipset to configure certain aspects of the removable chipset. For example, as discussed below, a ruleset may be generated based on the configuration data.

As shown by operation 504, the apparatus 300 includes means, such as processor 302, memory 304, communications hardware 306, and/or the like, for causing display of the configuration interface via a display screen of the device. In this regard, in some embodiments, components of the removable chipset (e.g., one or more of processor 302, memory 304, and communications hardware 306) may communicate with components of the device (e.g., one or more components of apparatus 200, such as communications hardware 206) to which the removable chipset is operably coupled in order to cause display of the configuration interface generated by the removable chipset on a display screen (or similar output mechanism) of the device. For example, instructions for causing display of the configuration interface may be communicated to apparatus 200.

In some embodiments, once a configuration interface is displayed, a user may interact with the configuration interface (e.g., via touches on a display screen, and/or peripheral devices such as a keyboard and/or mouse). In some embodiments, a user may provide certain configuration data which may be used by the removable chipset to generate rules for payments or other financial transactions performed by the removable chipset. In this regard, as shown by operation 506, the apparatus 300 includes means, such as processor 302, memory 304, communications hardware 306, or the like, for receiving the configuration data in response to user interaction with the configuration interface.

In some embodiments, the configuration data may comprise location restriction data. Location restriction data may comprise a geofence or other location-based security restriction. For example, a user may define specific locations within which transactions may be facilitated by the removable chipset (and, outside of which transactions may not be facilitated by the removable chipset). For example, for a removable chipset operably coupled to a user's laptop which never leaves their home, the user may provide location restriction data indicating no financial transactions are to be performed by the removable chipset when the location of the laptop is outside of the user's home (e.g., outside of a predefined radius according to GPS coordinates or the like).

In some embodiments, the configuration data may comprise device restriction data. Device restriction data may comprise indications of specific devices that the removable chipset is enabled to facilitate transactions for. For example, a user may define configuration data which includes a listing of identifiers for devices which they own or otherwise would like to interface with the removable chipset. The identifiers may comprise Media Access Control (MAC) addresses of the devices or similar numbers and/or codes by which the devices can be identified. If the removable chipset is operably coupled to a device that is not in the listing provided in the device restriction data, the removable chipset may not be able to perform or otherwise facilitate any payments or other financial transactions.

In some embodiments, the configuration data may comprise time restriction data. Time restriction data may comprise indications of one or more time periods within which transactions may be facilitated by the removable chipset (and, outside of which transactions may not be facilitated by the removable chipset). For example, for a removable chipset operably coupled to a user's mobile phone, the user may provide time restriction data indicating no financial transactions are to be performed by the removable chipset between the hours of 9:00 PM and 7:00 AM each day.

In some embodiments, the configuration data may comprise purchase restriction data. Purchase restriction data may restrict transactions facilitated by the removable chipset to only transactions of a certain type. For example, a removable chipset may be configured (with purchase restriction data) to only facilitate transactions related to utility bill payments. As another example, a removable chipset may be configured (with purchase restriction data) to only facilitate transactions related to food purchases (e.g., purchases made in restaurants, grocery stores, etc.).

In some embodiments, purchase restriction data may limit transactions of a certain type to a number of transactions over a specified time period. For example, the removable chipset may be limited to one electric bill payment every 30 days based on purchase restriction data. In the event that a second electric bill payment is attempted to be made within the 30-day period, the removable chipset may automatically prevent the second electric bill payment from being made.

Returning to FIG. 4, as shown by operation 406, the apparatus 300 includes means, such as processor 302, memory 304, rules engine 312, and/or the like, for generating a ruleset for the removable chipset based on the configuration data. In some embodiments, the ruleset may comprise one or more rules generated for the removable chipset based on the configuration data, for example, based on one or more of location restriction data, device restriction data, time restriction data, and/or purchase restriction data included in the received configuration data. The ruleset may be processed in connection with a transaction request to ensure that no rules of the ruleset are triggered. For example, a transaction being attempted at a time between 9:00 PM and 7:00 AM may trigger a rule indicating no transactions are permitted between the hours of 9:00 PM and 7:00 AM. In response to a triggered rule, the removable chipset may automatically deny the transaction request and thus prevent the transaction from occurring.

As shown by operation 408, the apparatus 300 includes means, such as processor 302, memory 304, transaction engine 310, and/or the like, for facilitating a financial transaction in accordance with the ruleset. A transaction request may be received by the removable chipset (e.g., via communications hardware 306) from one or more components of the apparatus 200 (e.g., communications hardware 206 of device 101) after having been generated by the apparatus 200 (e.g., processor 202, memory 204, and/or the like). In some embodiments, the transaction request may be automatically generated based on a predefined automatic payment configuration (e.g., a user has preconfigured a utility bill to be paid on a certain day each month). In some embodiments, the transaction request may be generated based on user input (e.g., the user is online shopping via the device 101 or using their device (operably coupled to the removable chipset) as a payment means at a POS device).

The transaction request may be an electronic request comprising a data structure that includes data related to the transaction which is being attempted. For example, the transaction request may comprise date and/or time information of the attempted transaction, transaction type (e.g., a category, such as bill payment, food, entertainment, etc.), a monetary amount required for the transaction, and/or other information.

The transaction request may also comprise authentication information. For example, a user may authenticate to the device 101 (e.g., via authentication engine 208 of apparatus 200) when attempting to perform the transaction. For example, a user may provide their fingerprint to a fingerprint reader on the device 101 (or other biometric factor or authentication factor) and the authentication engine 208 may then verify the fingerprint matches or satisfies a similarity threshold to a reference fingerprint (e.g., a previously stored fingerprint of the user). In response to a successful verification, the transaction request may be generated such that the transaction request includes authentication information, which may comprise an indication of a successful verification of the fingerprint (or other authentication factor). In this manner, the successful verification of the authentication factor by a device 101 to which the removable chipset is operably coupled may serve as a first authentication factor in a multi-authentication factor (MFA) process for the transaction. For instance, the user may be required to authenticate to both the device 101 and to the removable chipset (as further discussed below) in order to perform a transaction.

In some embodiments, the removable chipset may process the transaction request in connection with the ruleset for the removable chipset. In this regard, the removable chipset may perform an initial step of checking the transaction request against the ruleset to determine whether any rules are triggered. If one or more rules are triggered, the removable chipset may automatically deny the transaction request and thus prevent the transaction from occurring. Turning to FIG. 6, example operations are shown for authenticating a user in connection with facilitating a financial transaction.

As shown by operation 602, the apparatus 300 includes means, such as processor 302, memory 304, communications hardware 306, and/or the like, for receiving a first credential. The first credential may be received in response to a prompt to the user (e.g., via device 101 and/or removable chipset 102) to provide the first credential. The first credential may be an authentication factor which only the removable chipset is able to verify. In this regard, as shown by operation 604, the apparatus 300 includes means, such as processor 302, memory 304, authentication engine 308, and/or the like, for verifying the first credential. In some embodiments, the first credential may comprise a biometric factor, such as a voice input, which the removable chipset may then verify with a previously stored voiceprint for the user. The voice input may comprise an audible input by the user, e.g., the user may speak into a microphone (e.g., as part of communications hardware 306) or similar input device of the removable chipset 102. The previously stored voiceprint may be generated by analyzing and recording patterns and characteristics of the user's voice, including, for example, tone, pitch, pronunciation, and rhythm. This information may then be converted into a digital code and stored to later verify the user's identity when they provide a vocal input.

In response to an unsuccessful verification of the first credential, the removable chipset may notify the user of the unsuccessful verification of the first credential. In this regard, as shown by operation 606, the apparatus 300 includes means, such as processor 302, memory 304, communications hardware 306, and/or the like, for causing transmission of a notification of unsuccessful verification. For example, a notification may be presented to the user (e.g., via display screen of device 101) indicating that the first credential may need to be re-submitted (e.g., due to a bad reading of a voice input).

In response to a successful verification of the first credential, the method may continue to operation 608, wherein the apparatus 300 includes means, such as processor 302, memory 304, communications hardware 306, and/or the like, for receive an indication of a result of a verification, by the device, of a second credential. For example, as discussed above, a user may authenticate to their device (e.g., device 101 operably coupled to the removable chipset 102) in a separate process from the authentication process performed by the removable chipset (described above in connection with operations 602 and 604). By doing so, this dual authentication procedure provides additional protection against fraud; for example, if a thief were to obtain the removable chipset, it would be rendered useless to the thief. In this regard, the thief would also need the device itself, and also need to provide correct biometrics or other authentication factors separately to both the device and the removable chipset to perform a transaction. In some embodiments, as discussed above, the indication of the result of the verification by the device of the second credential may be received, for example, as part of the transaction request.

If the indication indicates an unsuccessful result of the verification of the second credential, the method may continue to operation 610, wherein the apparatus 300 includes means, such as processor 302, memory 304, communications hardware 306, and/or the like, for causing transmission of a notification of an unsuccessful verification. For example, a notification may be presented to the user (e.g., via display screen of device 101) indicating an unsuccessful verification of the second credential. In this regard, both the first credential must be verified (e.g., by the removable chipset) and the second credential must be verified (e.g., by the device to which the removable chipset is operably coupled to) in order for the removable chipset to continue processing the transaction request.

In response to a successful verification of the second credential (and first credential), the method may continue to operation 612, wherein the apparatus 300 includes means, such as processor 302, memory 304, transaction engine 310, or the like, for generating a payment token for the transaction. In this regard, the removable chipset may authorize the financial transaction based on the verification of the first credential and the second credential and subsequently generate a payment token for the transaction. In some embodiments, the payment token may comprise a unique string of characters which represents a payment method (e.g., a credit card or similar instrument). The payment token may be used to process a transaction without transmitting sensitive payment information (e.g., an actual card number) over a network. In this regard, the payment token provides an extra layer of security for the user. In some embodiments, in addition to the unique string of characters that represents the payment method, the payment token may also comprise an indication of at least a portion of an identifier associated with the device (e.g., device 101) and an indication of at least a portion of an identifier associated with the removable chipset 102. The identifier associated with the removable chipset 102 may comprise a unique device identifier assigned during manufacture of the removable chipset 102 or a private key allocated to the removable chipset 102 during provisioning of the removable chipset 102 (with a corresponding public key stored by a server at the time of allocation of the private key to the removable chipset 102). In embodiments using a private key as the identifier associated with the removable chipset 102, the private key may be rotated or otherwise changed as needed throughout its lifecycle. For example, each of the device and removable chipset may be associated with a respective identifier, such as a MAC address, that uniquely identifies the device or chipset. All or a portion of each MAC address may be included in the payment token for additional fraud protection. For example, payment processors (e.g., remote payment processing server 106) may use data contained in the payment token to detect suspicious or unauthorized transactions. If a payment token is used that contains an identifier or the device or the removable chipset and one of these items have been reported lost or stolen, the payment processor may flag the transaction as potentially fraudulent and decline it. That the payment token includes identifiers of the device and removable chipset may also streamline processes at the payment processor, for example, by reducing need for additional authentication. For instance, this may result in faster transaction approval.

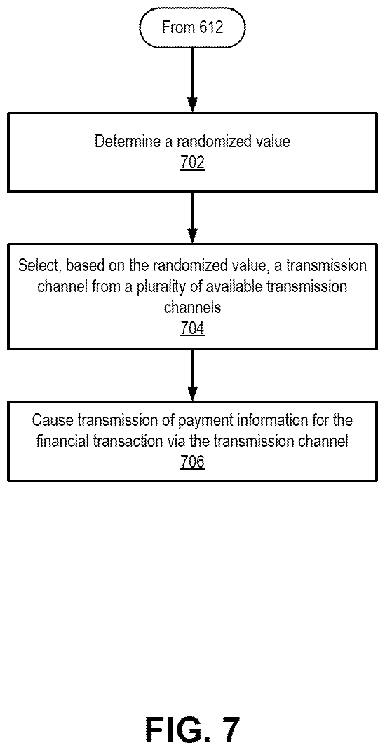

In some embodiments, once a payment token is generated, the removable chipset 102 may then select a transmission channel over which to transmit payment information including the payment token to a remote payment processing server. Turning to FIG. 7, example operations are shown for determining a transmission channel for payment information in connection with a financial transaction.

As shown by operation 702, the apparatus 300 includes means, such as processor 302, memory 304, randomizer circuitry 316, and/or the like, for determining a randomized value. The removable chipset may determine a randomized value using one or more RNGs, such as a PRNG, CS-RNG, and/or hardware-based RNG. At least a portion of the randomized value produced by the randomizer circuitry 316 may be used by the transaction engine of the removable chipset to select a transmission channel. In this regard, a predefined mapping of transmission channels to predefined values may be stored, such that a transmission channel that matches or in some way corresponds to the randomized value may be selected from the plurality of available transmission channels.

For example, from a plurality of available transmission channels may be transmission channels of a cellular network, such as a 6G cellular network. The transmission channels may comprise the means by which data is transmitted between devices and within the network infrastructure of the cellular network. The communication channels may comprise traffic channels, which are used to carry data traffic and are responsible for transmitting information exchanged between devices, such as, for example, payment information.

As shown by operation 704, the apparatus 300 includes means, such as processor 302, memory 304, transaction engine 310, and/or the like, for selecting, based on the randomized value, a transmission channel from a plurality of available transmission channels. As discussed above, the transaction engine may use the randomized value as a basis for determining which transmission channel to select for transmission of the payment information. Payment information may be better protected (e.g., against MITM attacks) by randomizing a selection of a transmission channel, using a randomized value, as any malicious third-party would have trouble determining which transmission channel would be submitting payment information from the removable chipset.

As shown by operation 706, the apparatus 300 includes means, such as processor 302, memory 304, communications hardware 306, and/or the like, for causing transmission of payment information for the financial transaction via the transmission channel. Advantageously, although the transaction request may originate from the device 101, the removable chipset 102 facilitates the actual transaction out-of-band from the device itself. For instance, the communications hardware 306 of the removable chipset, which may include, for example, a separate and distinct antenna or similar communication mechanism from an antenna or similar communication mechanism of the device may be used to cause transmission of the payment information. In this manner, components of the device never receive information related to what payment method was used to complete the transaction or what transmission channel the payment information for the transaction was communicated. This is beneficial, for example, in the instance in which the device may comprise malware, packet-sniffing software, or similar malicious items that can be used to eavesdrop on or obtain information related to a transaction.

In some embodiments, the removable chipset may be configured such that the removable chipset is able to be located in the event the removable chipset is lost, misplaced, or stolen. For example, in some embodiments, the location circuitry 318 of the removable chipset may comprise a micro-GPS tracking chip (e.g., embedded on a substrate as a component of the SOC) configured to receive GPS signals from satellites and transmit location data (e.g., GPS coordinates) using wireless connectivity (e.g., via a cellular network, such as a 6G cellular network) to a controlling device (e.g., device 101). In this regard, device 101 may have a GPS tracking application installed such that coordinates received from location circuitry 318 of the removable chipset 102 can be viewed or otherwise obtained by a user possessing the device 101. In this regard, the apparatus 300 includes means, such as processor 302, memory 304, communications hardware 306, location circuitry 318, and/or the like, for causing transmission of location data for the removable chipset to a device.

FIGS. 4-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved protection of sensitive information by facilitating financial transactions via a removable chipset. Example embodiments thus provide tools that overcome the problems faced when processing financial transactions using devices. For instance, by providing a removable chipset specifically dedicated to facilitating transactions, computational resources of other devices that would have otherwise been needed to facilitate said transactions may be freed up for other uses, thereby improving the computational power and efficiency of devices and/or networks. Moreover, embodiments described herein avoid exposure of sensitive financial information to components of a device (e.g., a mobile phone or the like) which may already be compromised (e.g., contain malware or the like).

As these examples all illustrate, example embodiments contemplated herein provide hardware-based technical solutions that solve real-world problems faced during facilitation of transactions. And while payment information security has been an issue for decades, the recently exploding amount of data made available by recently emerging technology today has made this problem significantly more acute, as the demand for mobile device-based transactions has grown significantly. Example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a mobile device; and
a removable chipset operably inserted into the mobile device and configured to store sensitive data and facilitate financial transactions using the sensitive data, wherein the removable chipset comprises:
communications hardware distinct from communications hardware of the mobile device and configured to receive configuration data,
a rules engine configured to generate a ruleset for the removable chipset based on the configuration data, and
a transaction engine configured to facilitate a financial transaction in accordance with the ruleset.

2. The system of claim 1, wherein the removable chipset is operably coupled to the mobile device via a terminal of the mobile device that is communicatively coupled to constituent components of the mobile device.

3. The system of claim 1, wherein the removable chipset further comprises:
interface generation circuitry configured to generate a configuration interface,
wherein the communications hardware is further configured to cause display of the configuration interface via a display screen of the mobile device, and
wherein the configuration data is received in response to user interaction with the configuration interface.

4. The system of claim 1, wherein the transaction engine facilitates the financial transaction by:
determining, by randomizer circuitry, a randomized value;
selecting, by the transaction engine and based on the randomized value, a transmission channel from a plurality of available transmission channels; and
causing transmission, by the communications hardware, of payment information for the financial transaction via the transmission channel.

5. The system of claim 4, wherein the payment information comprises a payment token for the financial transaction, and wherein the transaction engine further facilitates the financial transaction by:
generating the payment token, wherein the payment token is generated based at least on a device identifier associated with the mobile device and an identifier associated with the removable chipset.

6. The system of claim 5, wherein the payment token is generated based further on location data of the mobile device.

7. The system of claim 5, wherein the payment token is generated by the removable chipset such that the mobile device does not receive the payment token or an indication of the transmission channel.

8. The system of claim 5, wherein the identifier associated with the removable chipset comprises a private key allocated to the removable chipset.

9. The system of claim 4, wherein the plurality of available transmission channels are transmission channels of a cellular network.

10. The system of claim 9, wherein the cellular network is a sixth generation (6G) cellular network.

11. The system of claim 1, wherein the removable chipset is preconfigured to be associated with a first financial institution.

12. The system of claim 10, wherein the removable chipset is reconfigurable to be associated with a second financial institution.

13. The system of claim 1, wherein the configuration data comprises one or more of (i) location restriction data, (ii) device restriction data, (iii) time restriction data, and (iv) purchase restriction data.

14. The system of claim 13, wherein the rules engine generates the ruleset by generating one or more rules based on one or more of the location restriction data, the device restriction data, the time restriction data, and the purchase restriction data.

15. The system of claim 1, wherein the removable chipset further comprises an authentication engine configured to:
verify a received credential; and
authorize the financial transaction in response to verification of the received credential.

16. The system of claim 15, wherein the removable chipset authorizes the financial transaction based on a second verification, by the mobile device, of a second received credential by the mobile device.

17. The system of claim 1, wherein the removable chipset comprises location circuitry configured to cause transmission of location data for the removable chipset to the mobile device.

18. The system of claim 1, wherein the removable chipset comprises a system-on-chip (SOC).

19. The system of claim 1, wherein the mobile device comprises a chipset distinct from the removable chipset.

20. A method comprising:
receiving, by communications hardware of a removable chipset operably inserted into a mobile device, configuration data, wherein the communications hardware is distinct from communications hardware of the mobile device;
generating, by a rules engine of the removable chipset, a ruleset for the removable chipset based on the configuration data; and
facilitating, by a transaction engine of the removable chipset, a financial transaction in accordance with the ruleset.
